(19) United States
(12) Patent Application Publication
(10) Pub. No.: US 2002/0148750 A1
(43) Pub. Date: Oct. 17, 2002

(54) Simulated spray can generating an audible message

(75) Inventors: Timothy P. Clegg, Manhattan Reach, CA (US); Michael D. Ronk, Lawndale, CA (US); Donald M. Heinemann, Harbor City, CA (US)

Correspondence Address: JEFFER, MANGELS, BUTLER & MARMARO LLP, Tenth Floor, 2121 Avenue of the Stars, Los Angeles, CA, 90067, US

(73) Assignee: Clegg Industries, Inc.

(21) Appl. No.: 09/835,160

(22) Filed: Apr. 13, 2001

(51) Int. Cl. B65D 73/00; B65D 85/00; G08B 3/10

(52) U.S. Cl. 206/457; 206/459.1; 206/232; 340/384.3

(57) ABSTRACT

A sound emitting device is disclosed having a container shell, preferably in the shape of a simulated spray can, a sound generator located in the container shell and a trigger button that activates the sound generator. The sound generator is preferably configured to emit a spraying sound and a plurality of messages. Upon activation of the trigger button, the sound generator preferably generates a spraying sound followed by one of the plurality of messages. In a preferred embodiment of the invention, the sound generator is located in the cap of the container shell and the body of the container shell provides a receptacle for housing brochures, pamphlets and other marketing material.

### FIELD OF THE INVENTION

The present invention relates generally to a message delivery system cooperatingly associated with a container shell in the form of a spray can, and more particularly, to a message delivery system that is activated by pressing the trigger of a simulated aerosol spray can.

### BACKGROUND OF THE INVENTION

A standard aerosol spray can, of the type used to store insect repellant or disinfectant, includes a canister for storage of a particular liquid or gas such as insect repellant or disinfectant, a canister cap that sealingly engages the canister, and a trigger, the operation of which expels the matter stored in the canister. During operation, upon activation of the trigger, the expulsion of the matter from the canister creates a spraying sound. When the trigger is deactivated, the spraying sound ceases and no further matter is expelled. The aerosol spray can includes a label on the canister that identifies the contents of the canister and the associated brand name of the product.

It is desirable to provide a simulated spray can that includes a trigger, the activation of which generates a spraying sound, but does not cause any material to be expelled from the canister.

It is further desirable to provide a simulated spray can that appears to be a typical aerosol spray can but is a storage receptacle for brochures, pamphlets, marketing material, literature or any other object dimensioned to be received therein.

### SUMMARY OF THE PREFERRED EMBODIMENTS

A sound emitting device is disclosed having a container shell, preferably in the shape of a simulated spray can, a sound generator located in the container shell and a trigger that activates the sound generator. The sound generator is preferably configured to emit a spraying sound and a plurality of messages. The messages can vary depending upon the application. In a preferred embodiment of the invention, the messages can be short statements or songs, each lasting three or four seconds. Upon activation of the trigger, the sound generator preferably generates a spraying sound followed by one of the plurality of messages.

In a preferred embodiment of the invention, the sound generator is located in the cap of the container shell and the body of the container shell provides a receptacle for housing brochures, pamphlets, literature or any other object that is dimensioned to be received therein. The container shell preferably includes a detachable lid that allows the user to access the receptacle.

The sound emitting device is preferably configured have an outward appearance of a typical aerosol spray can. However, instead of storing disinfectant, insect repellant or other chemicals typically found in spray cans, the sound emitting device of the present invention stores non-aerosol items such as brochures, pamphlets, literature or other objects.

Other objects, features and advantages of the present invention will become apparent to those skilled in the art from the following detailed description. It is to be understood, however, that the detailed description and examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is a front view of a preferred embodiment of the simulated aerosol spray can of the present invention;

FIG. 2 is a cross-sectional view taken along line 2-2 of the simulated aerosol spray can shown in FIG. 1;

FIG. 3 is a top plan view of the simulated aerosol spray can shown in FIG. 1; and

FIG. 4 is an exploded view of a preferred embodiment of the simulated aerosol spray can of the present invention.

Like numerals refer to like parts throughout the several views of the drawings.

### DESCRIPTION OF THE PREFERRED EMBODIMENTS

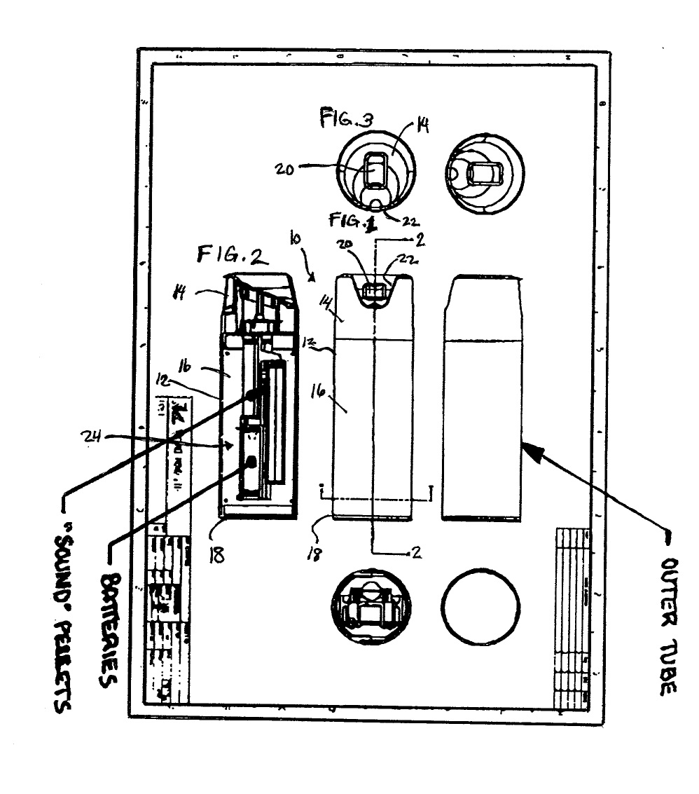

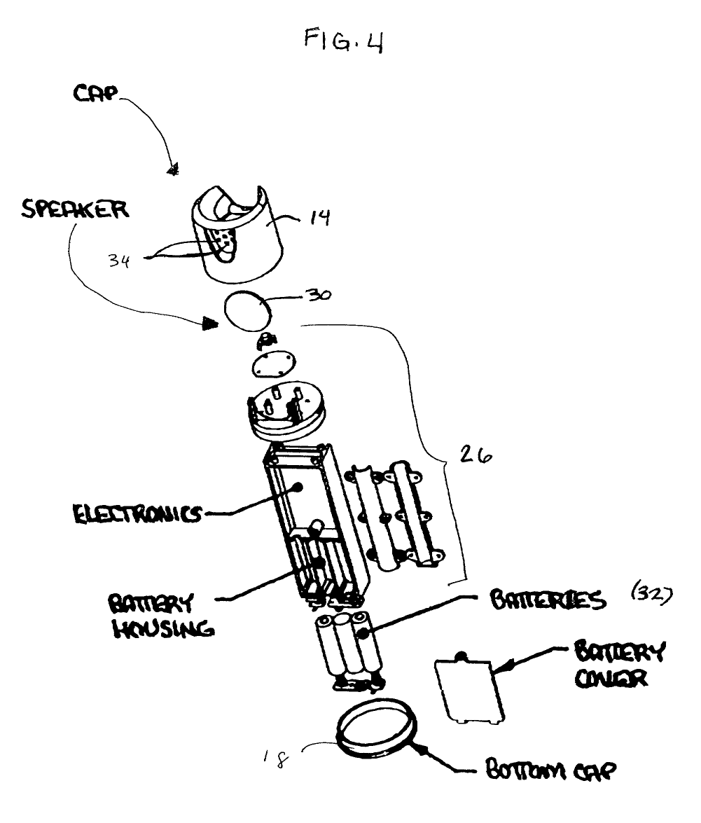

As shown in FIGS. 1 through 4, the present invention includes a sound emitting device 10 having a container shell 12 preferably formed in the shape of an aerosol spray can. The container shell 12 includes a cap 14, a canister body 16 and a bottom 18. As best shown in FIGS. 1 and 3, the cap 14 of the container shell 12 preferably includes a trigger 20 that is mechanically moveable with respect to the cap 14. In a more preferred embodiment of the invention, the cap 14 defines a cutout 22 dimensioned to receive an index finger and facilitate the user's access to the trigger 20.

The container shell 12 is preferably dimensioned such that it appears to be a typical commercial aerosol spray can that is sold in connection with insect repellants, disinfectants, hair sprays and similar consumer products. Moreover, the canister body 16 preferably includes labels thereon that are similar to the labels on commercial aerosol spray cans that identify the product and its brand.

The canister body 16 is preferably hollow and defines a receptacle 24 therein. In a preferred embodiment of the invention, a sound generator 26 is located in the container shell 12. The sound generator 26 preferably includes a speaker which emits sound using a microchip. By way of example, the microchip used can be a Sound Generator Model HT-2812 1 produced by Holtek Microelectronics Inc. of Taiwan R.O.C. The present invention is not intended to be limited to the microchip identified herein. Rather, any microchip that is capable of producing sounds or messages can be implemented into the present invention. Such microchip devices can be configured to produce a variety of sounds or messages, such as telephone ringing, business jingles, fanfare, car sounds, voice messages, speech, applause, door bells, sound effects, musical melodies, tones or the like.

As best shown in FIG. 4, the sound generator is operatively connected to a speaker 30 and a power source 32. In a preferred embodiment of the invention, the power source 32 is a battery pack. The cap 14 of the container shell 12 preferably includes perforations 34 to facilitate the emission of sound from the speaker 30 outward. The sound generator is further operatively connected to the trigger 20 such that activation of the trigger 20, also activates the sound generator 26 as described in further detail below.

In a preferred embodiment of the invention, the sound generator 26 is configured to produce a spraying sound. A spraying sound is used herein to refer to the sound that a typical aerosol spray can creates when its contents are emitted from the can. Additionally, the sound generator 26 is also configured to produce a plurality of messages. The contents of the messages produced by the sound generator 26 can vary depending on the application of the invention. The message could include speech or music, it could be in the form of a joke or include informational subject matter. The content of the message is not limited to the examples set forth herein. Rather, the message can include any sound effect or pertain to any subject matter desired.

The sound generator is preferably configured to produce more than one message, and more preferably configured to produce six or seven messages, each message being approximately three to four seconds in length. Upon activation of the trigger 20, the sound generator 26 emits a spraying sound, simulating a typical aerosol spray can. Thereafter, the sound generator 26 disseminates one of a plurality of messages stored by the sound generator 26. Each time the trigger 20 is activated, the sound generator 26 emits a spraying sound followed by one message.

In a more preferred embodiment of the invention, the sound generator 26 and any associated electronic equipment is molded into the cap 14 of the container shell 12, providing a storage area in the canister body 16. Specifically, the canister body 16 defines a receptacle 24 for receiving and storing objects. In one embodiment of the invention, the receptacle 24 is used to store brochures, pamphlets, marketing materials and other such literature. The receptacle 24 is not limited to storing the items listed above but can be used to store any object dimensioned to fit inside the receptacle.

In a preferred embodiment of the invention, the cap 14 of the sound emitting device 10 is preferably separable from the canister body 16 to allow access to the receptacle 24. If a removable cap 14 is provided, the bottom 18 is fixedly connected to the canister body 16. In one embodiment of the invention, the bottom 18 is integral with the canister body 16. In another embodiment of the invention, the bottom 18 is snap fit onto the canister body 16.

In yet another embodiment of the invention, the cap 14 is fixedly attached to the canister body 16 and access to the receptacle is provided through a removable bottom 18.

The simulated aerosol spray can is preferably has the same shape, size, and weight of the typical aerosol spray can. Moreover, the simulated aerosol spray can is preferably made of aluminum or other such materials that are used to make typical aerosol spray cans.

The embodiments described above are exemplary embodiments of a sound emitting device. Those skilled in the art may now make numerous uses of, and departures from, the above-described embodiments without departing from the inventive concepts disclosed herein. Accordingly, the present invention is to be defined solely by the scope of the following claims.

What is claimed is:

1. A sound emitting device, comprising:
a container shell;
a trigger button;
a sound generator located in the container shell, wherein the sound generator is configured to generate a plurality of messages; and
wherein, upon activation of the trigger button, the sound generator generates one of the plurality of messages.

2. The sound emitting device of claim 1 wherein the container shell comprises a spray can.

3. The sound emitting device of claim 1 wherein the sound generator is configured to generate a spraying sound.

4. The sound emitting device of claim 4 wherein, upon activation of the trigger button, the sound generator generates a spraying sound and one of the plurality of messages.

5. The sound emitting device of claim 1 wherein the plurality of messages comprises a musical arrangement of tones.

6. The sound emitting device of claim 1 wherein the plurality of messages comprises a prize winning message.

7. The sound emitting device of claim 1 wherein the sound generator is hidden inside of the container shell.

8. The sound emitting device of claim 1 wherein the container shell comprises a receptacle therein.

9. The sound emitting device of claim 8 wherein the receptacle is dimensioned to receive marketing material.

10. The sound emitting device of claim 9 further comprising a detachable lid that engages with the container shell to cover the receptacle.

11. A method of delivering a message, comprising the steps of:
providing a container shell having a trigger button and a sound generator therein;
pressing the trigger button;
producing a spraying sound from the sound generator; and
generating a message from the sound generator.

12. The method of claim 11 wherein the container shell comprises a spray can shape.

13. The method of claim 11 wherein the step of producing a spraying sound is followed by the step of generating a message.

14. The method of claim 11 wherein the message comprises a prize winning message.

15. The method of claim 11 wherein the message comprises a musical arrangement of tones.

16. The method of claim 11 further comprising the steps of:
providing a storage receptacle within the container shell;
storing an item in the storage receptacle of the container shell.

17. A simulated aerosol spray can, comprising:
a container shell shaped in the form of an aerosol spray can, the container shell having a cap, a body and a bottom;
a trigger button located on the cap of the container shell;
a sound generator located in the container shell and connected to the trigger button wherein the activation of the trigger button activates the sound generator;
wherein the sound generator is configured to generate a spraying sound and a plurality of messages, and wherein upon activation of the trigger button, the sound generator emits a spraying sound and one of the plurality of messages; and
a storage receptacle with the body of the container shell.

18. The simulated spray can of claim 17 further comprising the detachable lid that is connected to the bottom of container shell and in communication with the receptacle.

19. The simulated spray can of claim 17 wherein the sound generator is located in the cap of the container shell.

20. A can comprising:
an electronic assembly for delivering an audible sound;
a can top having a depressible area which upon depression activates the electronic assembly;
a canister; and
printed wrap having graphics thereon for suggesting to the user a brand name product.

21. The can according to claim 20 wherein the can top is removable from the canister.

22. The can according to claim 20 further comprising a can bottom which is removable from the canister.

23. The can according to claim 20 wherein the audible sound includes a spray sound and at least one message.

24. The can according to claim 20 wherein the audible sound includes a spray sound followed by at least one message.

25. A can comprising:
an electronic assembly for delivering an audible sound, wherein the audible sound includes a spray sound followed by at least one message;
a can top having a depressible area which upon depression activates the electronic assembly;
a canister;
printed wrap disposed on the canister having graphics thereon for suggesting to the user a brand name product; and
a can bottom attached to the canister.

26. The can according to claim 25 wherein the electronic assembly is at least partially housed in the can top.

27. The can according to claim 25 wherein the can bottom is integral with the canister.

28. The can according to claim 25 wherein the can bottom is detachable from the canister.

29. The can according to claim 25 wherein the can bottom is snap fit.
